(19) United States
(12) Patent Application Publication
(10) Pub. No.: US 2013/0030872 A1
(43) Pub. Date: Jan. 31, 2013

(54) METHODS AND SYSTEMS FOR PROVIDING A CLOSED LOOP MARKETING APP

(71) Applicant: Eugene Oksman, (US)

(72) Inventor: Eugene Oksman, (US)

(21) Appl. No.: 13/302,744

(22) Filed: Nov. 22, 2011

Related U.S. Application Data
(60) Provisional application No. 61/512,116, filed on Jul. 27, 2011.

(51) Int. Cl. G06Q 10/06

(52) U.S. Cl. 705/7.36

(57) ABSTRACT

Methods and systems for selling in a multi-tenant database system are provided. A sales information packet including sales material, daily schedule, and customer information are stored in the multi-tenant database. Sales personnel may download the sales information packet to a portable device. Sales personnel may present prospective clients with the sales material in text, image, and video formats. The sales personnel may provide feedback on the information packet, and/or collect feedback from the clients regarding the information packet. The portable user system may send geographical coordinates of the sales session, information about interactions with the input device of the portable device, along with the feedback, to the server system. The server may analyze the feedback and generate a report which may be used to determine the quality of the information packet, efficiency of sales schedules and the performance of the sales personnel.

### CLAIM OF PRIORITY

This application claims the benefit of U.S. Provisional Patent Application 61/512,116 entitled, METHODS AND SYSTEMS FOR PROVIDING A CLOSED LOOP MARKETING APP by Eugene Oksman, filed Jul. 27, 2011 (Attorney Docket No. 48-68/719PROV), the entire contents of which are incorporated herein by reference.

### CROSS REFERENCE TO RELATED APPLICATIONS

The following commonly owned, co-pending United States patents and patent applications, including the present application, are related to each other. Each of the other patents/applications are incorporated by reference herein in its entirety:

U.S. Provisional Patent Application No. 61/512,116 entitled, METHODS AND SYSTEMS FOR PROVIDING A CLOSED LOOP MARKETING APP by Eugene Oksman, filed Jul. 27, 2011 (Attorney Docket No. 48-68/719PROV); and

U.S. patent application Ser. No. ______ entitled METHODS AND SYSTEMS FOR PROVIDING A CLOSED LOOP MARKETING APP, by Eugene Oksman, filed ______, 2011 Attorney Docket No. 48-69/719PROV.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

One or more implementations relate generally to providing marketing applications.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

In conventional database systems, users access their data resources in one logical database. A user of such a conventional system typically retrieves data from and stores data on the system using the user's own systems. A user system might remotely access one of a plurality of server systems that might in turn access the database system. Data retrieval from the system might include the issuance of a query from the user system to the database system. The database system might process the request for information received in the query and send to the user system information relevant to the request. The rapid, secure, ease of use and efficient retrieval of accurate information and subsequent delivery of this information to the user system in a manner that is easy to understand has been and continues to be a goal of administrators of database systems is desirable.

Unfortunately, conventional sales techniques are not well organized. The tracking of sales opportunity and the sales personnel is a time consuming activity. Consolidating and analyzing feedback from customers regarding the products, sales presentation and the sales process is challenging due to numerous variables associated in the process. Organizing sales products, customizing the sales material, managing the schedule of sales personnel and studying the feedback from customers and sales personnel can help in improving the efficiency of sales personnel, the quality of sales materials, and the quality of sales offers.

Accordingly, it is desirable to provide techniques enabling improved sales processes using a database system.

### BRIEF DESCRIPTION OF THE DRAWINGS

In the following drawings like reference numbers are used to refer to like elements. Although the following figures depict various examples, the one or more implementations are not limited to the examples depicted in the figures.

FIG. 1A shows a block diagram of an embodiment of a system of sales;

FIG. 1B shows a block diagram of an embodiment of a portable user system of sales;

FIG. 2A shows a flow chart of an embodiment of a server-side method of sales in a multi-tenant database system;

FIG. 2B shows a flow chart of an embodiment of a server-side method of customization of sales material in a multi-tenant database system;

FIG. 2C shows an example code for customization of sales material in a multi-tenant database system;

FIG. 3 shows a flow chart of an embodiment of a client-side method of sales in a multi-tenant database system;

FIG. 4 shows a flow chart of an embodiment of a portable client-side method of sales in a multi-tenant database system;

FIG. 5 shows a screenshot of an embodiment of a daily schedule on a portable user system;

FIG. 6 shows a screenshot of an embodiment of a session evaluation on a portable user system;

FIG. 7A shows a screenshot of an embodiment of a sales presentation on a portable user system;

FIG. 7B shows a screenshot of an embodiment of a sales presentation with more information on a portable user system;

FIG. 8A shows a screenshot of an embodiment of a sales analytics report on sales presentation rating;

FIG. 8B shows a screenshot of an embodiment of a sales analytics report on number of views of certain presentations;

FIG. 9 shows a block diagram of an embodiment of an environment where in an on-demand database service might be used for methods and systems for closed-loop marketing;

FIG. 10 shows a block diagram of an embodiment of elements of FIG. 9 and various possible interconnections between elements in an embodiment for methods and systems for closed loop marketing;

FIG. 11 illustrates an embodiment of an environment within which the system for closed-loop marketing may operate;

FIG. 12 illustrates embodiment of elements of FIG. 11 and various possible interconnections between elements of the environment.

### DETAILED DESCRIPTION

### General Overview

Systems and methods are provided for a closed loop marketing application in a multi-tenant database network system.

As used herein, the term multi-tenant database system refers to those systems in which various elements of hardware and software of the database system may be shared by one or more customers. For example, a given application server may simultaneously process requests for a great number of customers, and a given database table may store rows for a potentially much greater number of customers. As used herein, the term query plan refers to a set of steps used to access information in a database system.

Next, mechanisms and methods for providing closed loop marketing application in a multi-tenant database network system will be described with reference to example embodiments.

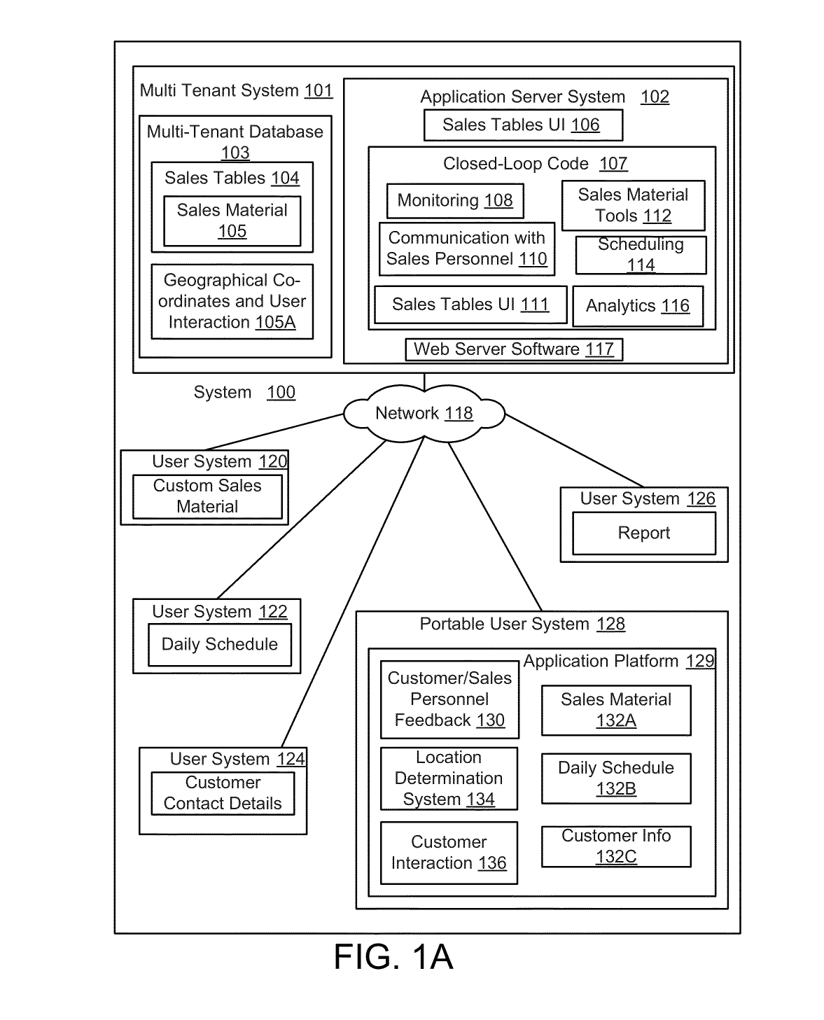

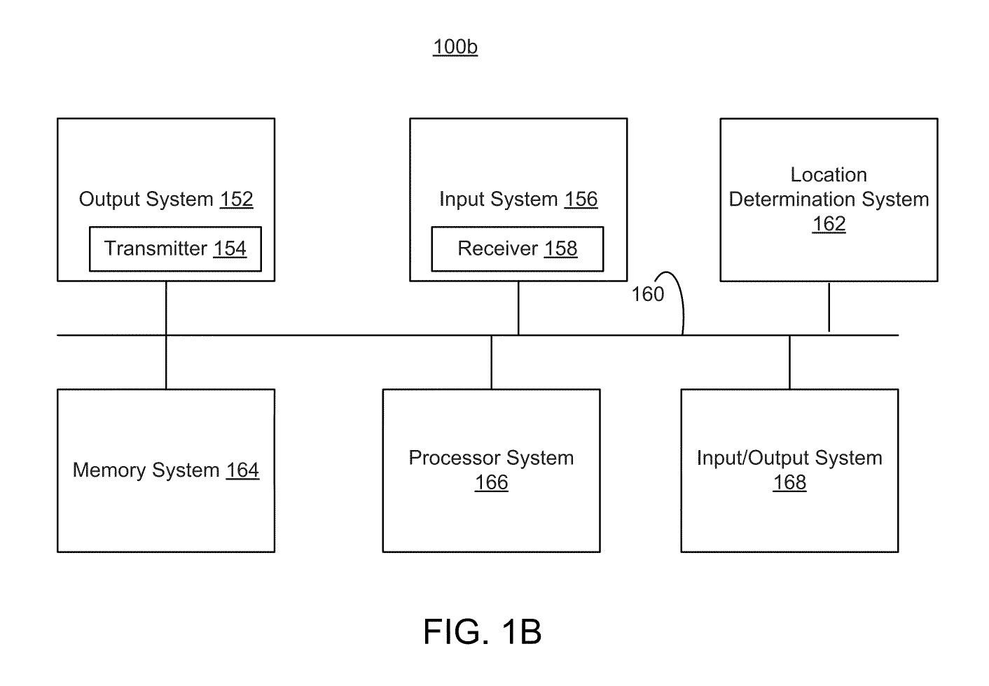

FIG. 1A shows an embodiment of system 100, a system for providing closed loop marketing in an on-demand multi-tenant database system. In an embodiment, system 100 may host application server system 102, multi-tenant database 103, sales tables 105, geographical co-ordinates and interaction 105A, closed-loop code 107, monitoring 108, communication with sales personnel 110, sales material tools 112, scheduling 114, analytics 116, network 118, user system for custom sales material 120, user system for daily schedule 122, user system for customer contact details 124, user system for report 126, portable user system 128, application platform 129, customer/sales personnel feedback 130, sales material 132A, daily schedule 132B, customer info 132C, location determination system 134, and customer interaction 136. In other embodiments system 100 may not have all of the elements or features listed and/or may have other elements or features instead of or in addition to those listed.

System 100 is a sales system for providing sales tool for the tenants of the multi-tenant database system. Different people in an organization may be involved in different capacities in the sales system. For example, sales managers, product experts (engineers and other developers of the product), and sales personnel may be involved in the sales system. Customer contact information, sales accounts associated with sales personnel, sales material, and daily schedules of sales persons may be stored in the multi-tenant database. Sales material may be in a multi-media format including any one of, any combination of, or all of text, audio, image, and/or video. The sales material may be an interactive document stored in a content library on the multi-tenant database. Sales material may include sales brochures, slide show, and/or other presentations. In this specification sales material and sales collateral may be used interchangeably to mean information/documents helpful for performing sales operation. Sales material may also include templates for letters and/or emails with information about a product that may be required for sales activities. Sales material may be downloaded from the multi-tenant database to a portable user system. During and/or after a sales session, information may be gathered by the sales personnel on the portable system and may be uploaded to the multi-tenant database. In an embodiment, a sales session may include a visit to the customer location and presenting the sales material.

Feedback from customer and sales personnel may also be collected along with customer interaction. Customer interaction may include interaction of the input device with the portable user system. The gathered information related to customer interaction and feedback may be analyzed to generate various reports. The reports may be used to study the effectiveness of the sales material, the skills of the sales personnel, and/or the efficiency of the schedule, which in turn may be used to improve the sales system and eventually the profitability of the tenant's organization. In this specification, sales activities may include, but are not limited to, a sales session, scheduling appointments, scheduling sales sessions, generating customized sales material, managing sales material, managing sales accounts, creating and/or managing customer information, such as people at customer sites or a potential customer to contact and/or requirements that a product needs to meet for a customer. In addition or alternatively sales activities may include managing lead information, and/or collecting feedback from sales personnel and/or customers. System 100 includes the system of the multitenant database service provider as well as the systems of the tenants and the customers of the tenants.

Multi-tenant system 101 is the portion of the multitenant database that is located at the site of the multitenant database provider. Application server system 102 may be a host system that hosts a web server software 117 and closed-loop code 107. Multi-tenant database 103 may be a database system with multiple tenants. Each tenant has a degree of access to at least a portion of the database system that may or may not be the same as the degree of access as other tenants. Each tenant may be granted exclusive usage of the portion of the multitenant database that the tenant has tenancy in. In an embodiment, usage of the multi-tenant system is to provide the tenant on-demand services. In other words, usage of the multitenant system may be provided as a service, so that the tenant does not need to worry about maintaining the database or worry about the details of how a database works if the tenant does not desire to be concerned with such issues. Each tenant may be an individual or an organization, and each tenant may have representatives, members, employees, customers and/or other entities associated with the tenant, which in turn may also have different degrees of access to the tenant's portion of the database as a result of the tenant's tenancy of the multi-tenant database. The degree of access granted to those associated with the tenant and/or which entities (e.g., representatives, members, employees, customers and/or other entities) are associated with the tenant may be determined by the tenant. The database system may include multiple databases, and each database may be partitioned and/or otherwise shared amongst multiple tenants. Multi-tenant database 103 may have any number of tenants and any number of user systems and/or portable user systems associated with any given tenant, which may access that tenant's portion of the database.

Sales table 104 may include a set of one or more tables of the tenant for storing information about sales leads, sales opportunities, quotes for products and/or services given potential clients, accounts, price books, and/or current customers of the tenant. Sales material 105 includes the brochures, slide shows, videos, pamphlets, scholarly articles about the benefits of a product, and/or other materials for promoting a product of the tenant. Sales material 105 may be stored in sales tables 104 or another part of multitenant system that the tenant has use of. Geographical co-ordinates and interaction 105A stores the geographical coordinates and interaction of the portable system received from the portable user system. Sales tables UI 106 is the user interface that is used for interacting with multitenant database 103 when not accessing the sale tables 104, via the closed-loop software.

Closed-loop code 107 services the entire sales process including preparations of sales materials, scheduling a sales person to meet with potential customers, monitoring the sales pitch, receiving feedback about the sales material and/or sales person, and/or analyzing the effectiveness of the presentation, the sales person's usage of the sale material, the sales persons, and/or the product. Closed-loop code 107 may run machine instructions for various sales activities. Closed-loop code 107 may include code for tracking sales activities, communicating with sales persons, customization of sales material, managing sales lead information, scheduling sales personnel, and analyzing the feedback from sales sessions. Monitoring 108 may be part of closed-loop code 107, which may monitor sales activities by collecting information about sales activities. Monitoring 108 may record information from meetings between customers and sales personnel, such as how much time the sales person spent discussion a particular article, brochure or other sales promotional material. Monitoring 108 may collect information about how many taps and/or keystrokes are entered while viewing each page and/or cursor motions on the page. Monitoring 108 may collect information about the content or functionality associated with the taps, cursor motions, and/or keystrokes that are entered while viewing each page. Monitoring 108 may also collect information about the current location of the sales person. Monitoring 108 may also include code for tracking sales leads, prospects, and/or customers. Monitoring 108 may collect feedback from sales personnel and/or customers, collect information related to interactions with customers, collect geographical coordinates of the portable user systems, and the duration of sales session. Communication with sales personnel 110 may include code for automatically sending communications to sales personnel, such as reminders of upcoming appointments. Verifying the access to documents and the upload/download/read/write privileges to document access by the sales personnel, communication with portable user system 128, and communication with location determination system. Sales tables UI 111 is the user interface for accessing sales tables 103, via Closed-loop code 107. Sales tables UI 111 is optional. Those accessing sales tables 103, such as a salesperson on the road, may have a tendency to use different types of devices, such as tablet computers and/or cell phones while accessing the data when, and sales table UI 111 may be better adapted for handling portable devices than sales tables UI 106.

Sales material tools 112 may include tools for preparing sales material 105 and/or altering sales materials 105. In an embodiment, the preparation and editing of sales materials may be performed without invoking the native code via which the customization is ultimately performed. Scheduling 114 may include calendaring applications and/or other the code for scheduling sales activities and checking the scheduled activities by the sales manager and/or sales personnel. Scheduling 114 may also include code for scheduling sales sessions. Analytics 116 may be the code for analyzing information collected about usage of sales materials and/or interactions between sales persons and customers, for example. Data collected regarding sales material from sales personnel and customer feedback, interaction (which will be discussed later in conjunction with FIG. 1A) of the portable user system with the customer, and input from portable system may be used to generate reports. Input from portable user system may include geographical co-ordinates of the portable system, start and end time of the sales session, and time spent on each page of a sales presentation/document. Interaction of the portable user system may include total number of user inputs made by a user of the portable system, user inputs per page and frequency of user inputs on a touch-sensitive device, or clicks from a mouse or key stroke from a keyboard. The data collected is used to analyze the effectiveness of the sales material, salesperson, and/or the customer appeal of a product. Analytics 116 may determine whether the salesperson spent an appropriate amount of time on each page of the sales material, the degree to which the sales person interacted with each page and/or which portions of each page the salesperson interacted with. Analytics 116 may provide any of a number of reports about the effectiveness of the sales person, sales material, and/or the appeal of the product to a potential customer. Analytics 116 may also compute information that is displayed on a dashboard for a sales manager and/or other tenant personnel, for providing a quick overview of current sales activities.

Web server software 117 handles communications between application server 101 and users, such as sales persons and/or other employees of a tenant. Web server software 117 serves webpages to the user in response to receiving input from users. The particular webpages served may be a result of invoking sales tables UI 106, closed-loop code 107, and/or other applications running of application server 101.

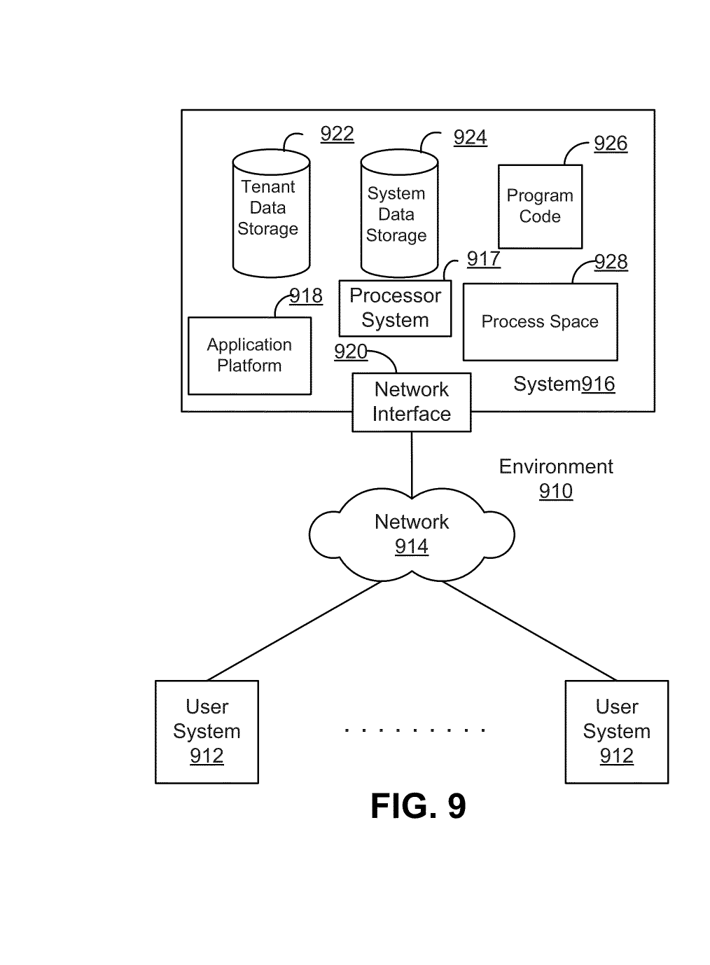

Network 118 (which is further discussed in conjunction with FIG. 9) may be any network and/or combination of networks of devices that communicate with one another (e.g., and combination of the Internet, telephone networks, and/or mobile phone networks). Application server system 102 may interact with any of a variety of user systems via a network using a network interface (which is also further discussed in conjunction with FIG. 9).

User system 120-user system 126 represents user systems which connect to application server system 102, via network 118. User systems may be devices with at least a processor system having one or more processors, a memory system, an input/output system, and a network interface. One or more user system provides input to server 102. User systems may or may not be portable devices. For example, user system for custom sales material 120 may belong to an employee of the tenant that works on designing and perfecting the sales material. User system 120 may provide custom sales material, via sale material tools 112, which may be used to generate customized sales material and/or update and maintain the sales material in the content library of the database. User system for daily schedule 122 may belong to a sales manager, and may be used to create and/or alter a daily schedule, via scheduling 114. User system for customer contact details 124 may belong to an account manager and may be used to create new sales accounts, review sales accounts, review sales opportunities and maintain customer contact details, via sales tables UI 106 and/or 111. User system for report 126 may belong to a sales analyst and may be used to request, and/or determine the requirements for, reports and/or receive reports generated by application server system 102. In an example, any or user systems 120-126 may be used by sales managers or technical experts.

Portable user system (described later in conjunction with FIG. 1B) 128 represents a user system that connects to application server system 102, via network 118. Portable user system 128 may be a device with at least a processor system having one or more processors, a memory system, an input/output system, and a network interface and application platform 129. Portable user system 128 may be a standalone system or may be connected to application server system 102 and may be a portable device that can be taken along with sales personnel for presenting promotional material during sales sessions and may be used collect feedback and other information from sales personnel as well as customers. Portable user system 108 may also collect information about geographical co-ordinates, and user interaction with the sales material, which is uploaded to the multi-tenant system 101. Portable user system 128 may receive updated or new documents by synchronizing with the content library (in sales material 105) on application server system 102. Consequently, the sales person may have access to sales material that was updated while the salesperson was traveling between potential customers. Portable user system 128 may be used to present sales material (e.g., as a slide show) to the customers. User system 128 may also be used for emailing documents, taking notes, and recording follow-up tasks. Application server system 102 may include one or more portable user system 128. In an example, portable user system 128 may be used by sales personnel.

User systems 120-128 may each be separate systems or any combination of user systems 120-128 may be combined together. User systems 120-128 may communicate with multitenant system 101 and application server system 102 (via, web server software 117) asynchronously, which may include asynchronous communication with sales tables UI 106 and/or closed loop system 107. In other words, each of systems 120-128 may be capable to sending one or more requests to closed loop code 107 and/or sales table UI 106 and continue to interact with the User Interface provided, without waiting for the one or more requests to be processed and/or the results of the requests to be returned. In an embodiment, the user system 120 may update the draft version of the sales material or collaborate on the changes, make modifications and finally publish the document. The published document may be updated on the portable user system 128 without the portable user system requesting an update or while the portable user system is performing other tasks. Each of user systems 120-128 may communicate independently with multitenant system 101. System 100 allows multiple users of the tenant (e.g., via user systems 120-128) that handle different aspects of the sales process to interact simultaneously with multitenant system 101 and/or closed loop code 107.

Application platform 129 may include applications for sales personnel to interact with and provide information to closed loop code 107. Application platform 129 may collect feedback from customers and/or sales personnel. Application platform 129 may run a location determination system, store sales material, run a calendaring application, store a daily schedule of the sales person that uses the portable user system 128. Application platform 129 may also collect interactions of the sales person with the sales material during meetings with customers. Application platform 129 may collect customer information and/or customer interactions with portable system 128. Customer/sales personnel feedback 130 may be the portion of application platform 129 that provides an interface to collect feedback from customer and/or sales personnel regarding the effectiveness of sales material, the effectiveness of the session, and/or collect feedback from customers regarding the performance of sales personnel. Sales material 132A may store and run the sales material downloaded from application server system 102, add notes, add follow up tasks, email documents to customer. Daily schedule 132B may store and display the daily schedule downloaded from application server system 102, add impromptu schedule, and schedule next the appointment. Customer info 132C may display customer information, add new customer information, and/or update customer information. The portable user system 128 may or may not be able to modify or create sales material. Location determination system 134 may be a global positioning system or any other technology that may used to provide the geographical location and the time of portable user system 128. Location determination system 134 may transmit the geographical location of the metrics such as time of the sales session, sales presentations selected for the session, and name of the sales person at the start, and/or finish and/or during the sales presentation.

Customer interaction 136 may collect information about the interactions of the salesperson with the input device, such as finger taps on a touch screen, pressing of keys on a keyboard, cursor motions, and/or motions of a stylus used with the portable user system. Interactions with portable user system 128 may be collected during the sales session and transmitted to application server system 102 during and/or at the end of the sales session. The number of interactions of the input device, the frequency of interactions with the input device, the number of interactions per page/display screen, the time spent on each page/screen, and the number of times a page is visited may be collected to estimate the effectiveness of the sales material, sales person, and/or sales session.

FIG. 1B shows an embodiment of portable system 100b, a portable user system for providing closed loop marketing in an on-demand database system. In an embodiment, portable system 100b may include output system 152, transmitter 154, input system 156, receiver 158, communications system 160, location determination system 162, memory system 164, processor system 166, and input/output device 168. In other embodiments portable system 100b may not have all of the elements or features listed and/or may have other elements or features instead of or in addition to those listed.

Portable system 100b is an example of portable user system 128, which may be used for delivering closed loop marketing in a multi-tenant database system. Portable system 100b may be a portable internet appliance, such as a laptop, notepad, a tablet computer, iPad, mobile phone, a smart phone or another internet appliance. In another embodiment, portable system 100b may be an internet appliance that is not portable.

Output system 152 may include any one of, some of, any combination of, or all of a monitor system, a handheld display system, a printer system, a speaker system, a connection or interface system to a sound system, an interface system to peripheral devices and/or a connection and/or interface system to a computer system, intranet, and/or internet, for example. Transmitter 154 may include a transmitter and/or an antenna for transmitting signals/data to the server system. Input system 156 may include any one of, some of, any combination of, or all of a keyboard system, a touch sensitive screen, a tablet pen, a stylus, a mouse system, a track ball system, a track pad system, buttons on a handheld system, a scanner system, a microphone system, a connection to a sound system, and/or a connection and/or interface system to a computer system, intranet, and/or internet (e.g. IrDA, USB). Receiver 158 may include a receiver and/or an antenna. Communications system 160 communicatively links output system 152, input system 156, location determination system 162, memory system 164, processor system 166, and/or input/output system 168 to each other. Communications system 160 may include any one of, some of, any combination of, or all of electrical cables, fiber optic cables, and/or means of sending signals through air or water (e.g. wireless communications), or the like. Some examples of means of sending signals through air and/or water include systems for transmitting electromagnetic waves such as infrared and/or radio waves and/or systems for sending sound waves.

Location determination system 162 may include a Global Positioning System (GPS) or any other means of determining a location of portable system 100b. For example, the position of use system 100b could be triangulated based on signals sent to and/or from the nearest three repeaters or other location detecting devices. Memory system 164 may include, for example, any one of, some of, any combination of, or all of a long term storage system, such as a hard drive; a short term storage system, such as random access memory; a removable storage system, such as a floppy drive or a removable drive; and/or flash memory. Memory system 164 may include one or more machine readable mediums that may store a variety of different types of information. The term machine-readable medium is used to refer to any medium capable carrying information that is readable by a machine. One example of a machine-readable medium is a computer-readable medium. Another example of a machine-readable medium is paper having holes that are detected that trigger different mechanical, electrical, and/or logic responses. In system 100, memory system 164 may store customer/sales personnel feedback, sales presentation, daily schedule, customer information and customer interaction. Memory system 164 may store application platform 129. Processor system 166 may include any one of, some of, any combination of, or all of multiple parallel processors, a single processor, a system of processors having one or more central processors and/or one or more specialized processors dedicated to specific tasks. Also, processor system 166 may include one or more Digital Signal Processors (DSPs) in addition to or in place of one or more Central Processing Units (CPUs) and/or may have one or more digital signal processing programs that run on one or more CPU. Input/output system 168 may include devices that have the dual function as input and output devices. For example, input/output system 168 may include one or more touch sensitive screens, which display an image and therefore are an output device and accept input when the screens are pressed by a finger or stylus, for example. The touch sensitive screen may be sensitive to heat and/or pressure. One or more of the input/output devices may be sensitive to a voltage or current produced by a stylus, for example. Input/output system 168 is optional, and may be used in addition to or in place of output system 152 and/or input device 156.

### Server-Side Method of Sales

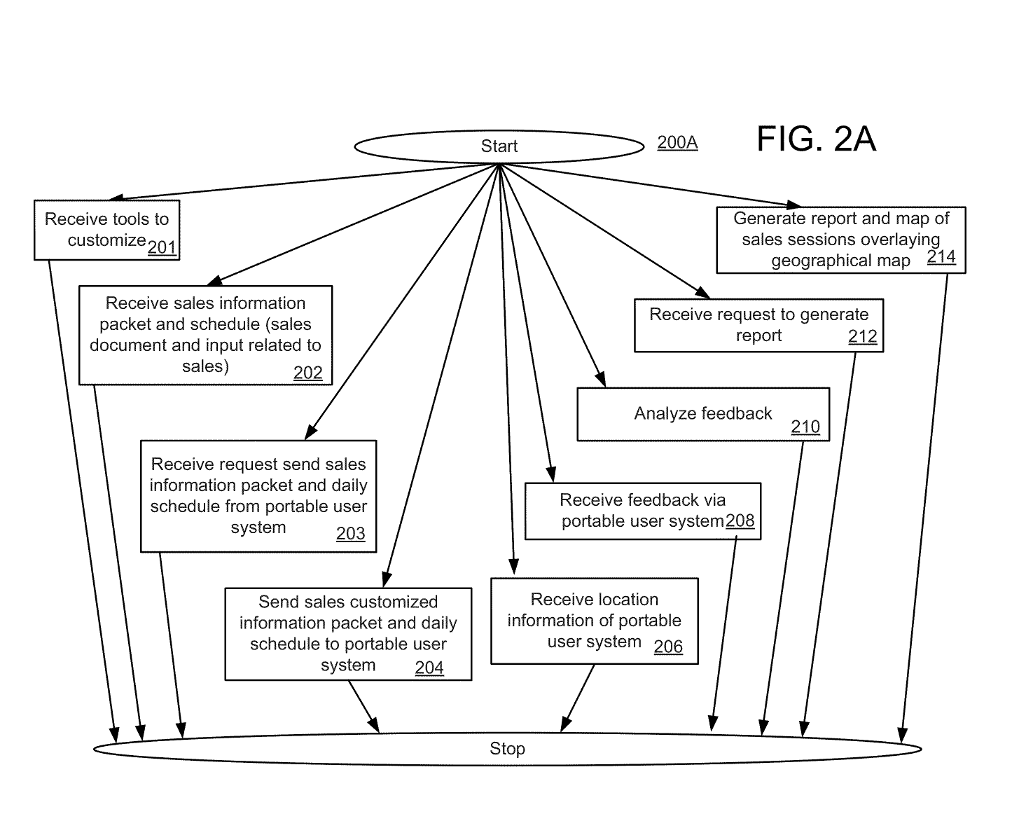

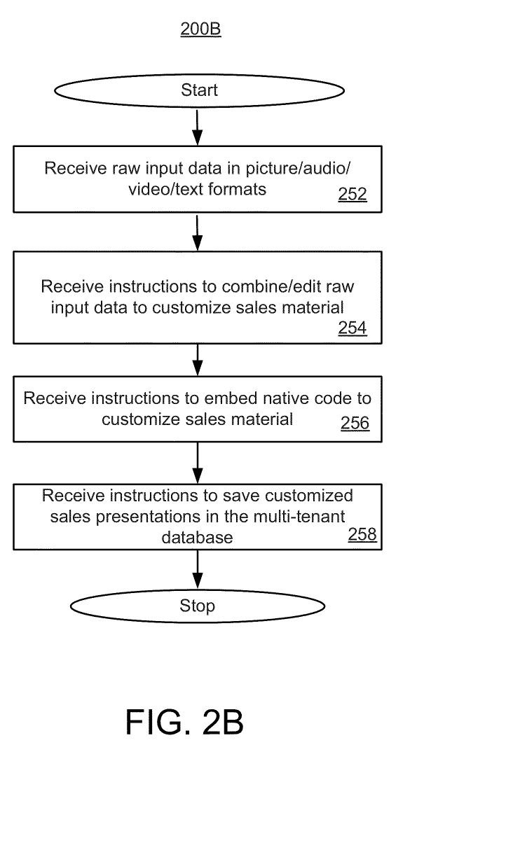

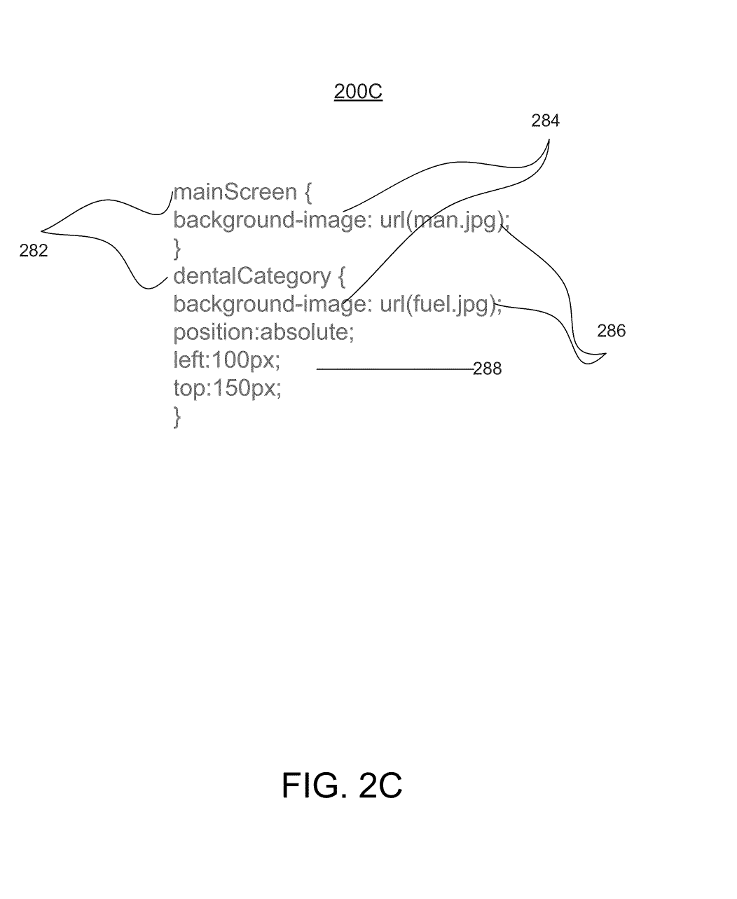

FIG. 2A shows a flowchart of an embodiment of a server-side method 200 for sales in a multi-tenant database system. In step 201 the server system sends tools to customize sales information packet which may include sales data, customer requirements, sales lead information, technical information, and industry standard software tools. Customization may include creating new sales material or modifying existing sales material or creating multi-media presentation or creating an interactive presentation tailored to specific needs of the customer. Customization may be performed using industry standard tools and standards.

In step 202, the server system receives sales information packet from one or more user systems. The sales information packet may include, but not limited to custom sales material and sales presentation for sales material, daily schedule, customer contact details, and sales account. Custom sales material may be information for customizing sales material using the information collected from user systems. Customization of the sales material may be performed by any one of or all of the administrators of the tenant of the multi-tenant database, the sales manager, the sales personnel, and any one with sales material creation privileges. Sales information packet (e.g. sales presentations) may be received from different user systems or from one user system, and all of or some parts of sales information packet may be received. The content of sales information packet may be new or an update to the existing information, and may be customized to each customer and/or sales personnel. Step 202 is further discussed in FIG. 2B.

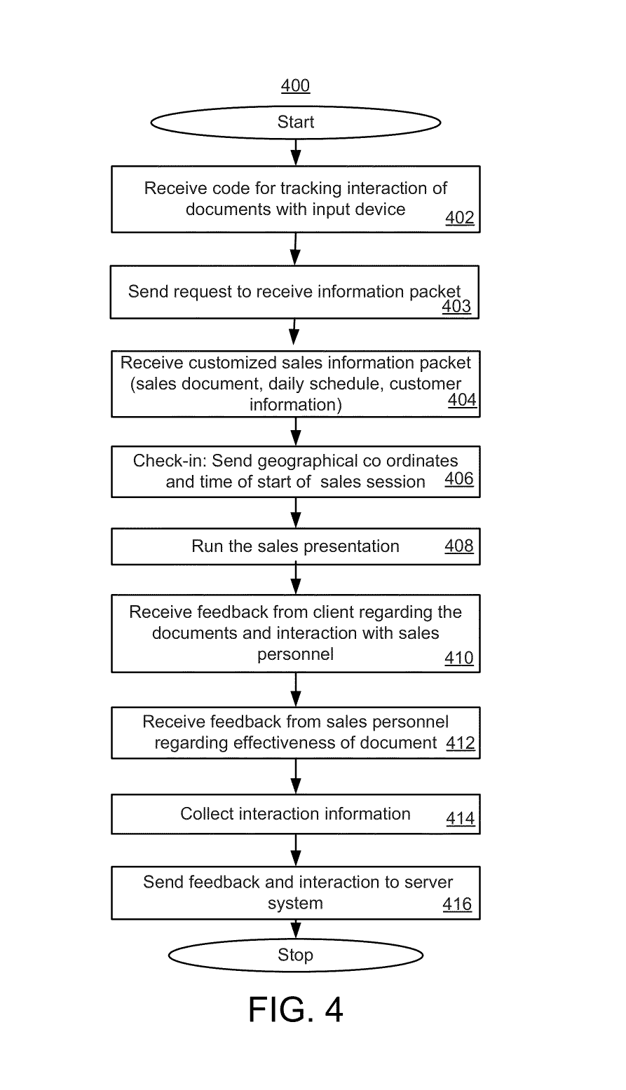

In step 203, the server system receives a request to send sales information packet and daily schedule to the portable user system. In step 204, the sales information packet may be customized for a customer and/or for a particular sales person or set of sales personnel, and may be sent to the portable user system along with the schedule of the sales personnel. Step 204 may be accomplished by synchronizing all or parts of the content library with the contents of the portable user system 128. The sales information packet may include some of the parts of the sales information received in step 202. In step 206 the server system receives location information from the portable user system when the sales person starts the sales session by checking-in (the sales session is further discussed in conjunction with FIG. 4).

In step 208 the server system receives feedback and customer interaction from the portable user system at the end of the sales session and/or during the sales session. The feedback may be from the customer and/or the sales personnel. Feedback from the customer may include assessment of the sales personnel, sales material, and overall evaluation of the session with the sales personnel. Feedback from sales personnel may include but is not limited to the effectiveness of the sales material, notes, follow up tasks, reminders, updated customer information, and/or an entry for the next appointment with the client.

In step 210, the server system analyzes and aggregates the information received from feedback, customer interactions, and location determination system during the sales session. In step 212, a request to generate a report along with the parameters for generating the report may be received from a user system. In step 214, the report may be generated. The type of report generated may be based on the input received from the user system. Reports may include effectiveness of the content, effectiveness of the sales personnel and conversion rate between sales presentation and sales. In an embodiment, a report may include an indication of the most effective sales material and busiest sales personnel. In another embodiment, the report may include the amount of time that salesperson spent discussing different portions of the sales material and the extent to which the salesperson interacted with different parts of the sales material while presenting the sales material. The report may include the time spent on a particular sales material and/or conversion rate of a sales material to sales. In an embodiment, a map may be overlaid with the current locations of salespeople and/or the locations of the appointments of that the salespeople have scheduled. The map may be tailored to a salesperson to aid the salesperson in finding and keeping appointments and/or to a sales manager so that the sales manager can monitor the current activities of the salespeople in the field in real time.

In an embodiment, each of the steps of method 200A may be a distinct step. In other embodiments, method 200A may not have all of the above steps and/or may have other steps in addition to or instead of those listed above. The steps of method 200A may be performed in another order. Subsets of the steps listed above as part of method 200A may be used to form their own method. In an embodiment, there could be multiple instances of method 200A.

FIG. 2B shows a flowchart of an embodiment of a server-side method 200B for customization of sales material in a multi-tenant database system. In an embodiment, method 200B may be performed by a sales manager, a product expert, and/or any one with sales material creation privilege. In step 252, the server system receives input data from one or more user systems. The input data may one or a combination of the following, pictures, video, audio, plain text and/or text documents. In step 254 the server receives instructions to perform operations such as combining or adding or deleting or editing the input data, which is an intermediate step of customizing sales material. In step 256 the server receives instructions to customize the sales material. An example of code for embedding the code into the-input is shown in FIG. 2C. In step 258, the server receives instructions to save the customized sales material on the multi-tenant database in sales material 105. The user does not need to write any code in customizing the sales material.

In an embodiment, each of the steps of method 200B may be a distinct step. In other embodiments, method 200B may not have all of the above steps and/or may have other steps in addition to or instead of those listed above. The steps of method 200B may be performed in another order. Subsets of the steps listed above as part of method 200B may be used to form their own method. In an embodiment, there could be multiple instances of method 200B.

FIG. 2C shows an example 200C of sales material customization code. Example 200C is implemented with Cascading style Sheets (CSS) for displaying HTML elements. Example 200C shows the image for the main screen as shown in screenshot 700A and dental screenshot 700B. Example 200C has selector 282, property image 284, image 286 and position 288. In other embodiments, example 200C may not have all of the elements listed and/or may have other elements instead of or in addition to those listed.

Selector 282 shows the selector for HTML display element. Property image 284 is the property for background image. Image 286 is the image. Position 288 shows the position of the selector dentalCategory.

### Client-Side Method of Sales

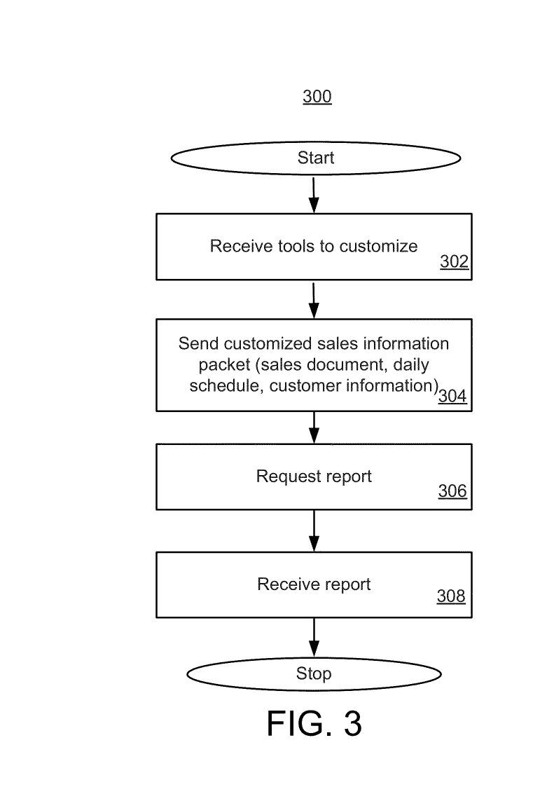

FIG. 3 shows a flowchart of an embodiment of a client-side method 300 for sales in a multi-tenant database system. Method 300 maybe performed by user system 120, 122, 124, or 126 and may be performed by a single user system or different user systems. In step 302, the user system receives tools to customize a sales information packet which may include sales data, customer requirements, sales lead information, technical information, and industry standard software tools. Customization may include creating new sales material or modifying existing sales material or creating multi-media presentation or creating an interactive presentation or a presentation tailored to specific needs of the customer. Customization may be performed using industry standard tools and standards. In an embodiment, step 302 may be performed by a technical expert or a sales manager.

In step 304 customized sales information packets may be sent by one or more user systems to the server system along with a daily schedule of one or more sales personnel and customer contact details. In an embodiment, the daily schedule may be prepared by a sales manager. In step 306 one or more user systems may send a request for a report along with the type of report. The request for report may include a request to perform some analytics. In step 308 one or more user systems receive the report generated by the server system based on request in step 306.

In an embodiment, each of the steps of method 300 may be a distinct step. In other embodiments, method 300 may not have all of the above steps and/or may have other steps in addition to or instead of those listed above. The steps of method 300 may be performed in another order. Subsets of the steps listed above as part of method 300 may be used to form their own method. In an embodiment, there could be multiple instances of method 300.

FIG. 4 shows a flowchart of an embodiment of a portable client-side method 400 for sales in a multi-tenant database system. Method 400 may be maybe performed by portable user system 128. A system may have any number of portable user systems.

In step 402, the portable user system receives code to track interaction of the sales material with input devices. In an embodiment, the input device may be a touch sensitive screen and the code may track the taps of a finger on the touch sensitive screen. Step 402 may be performed once and need not be performed subsequently. In step 403, the portable user system sends a request to the server system to receive the information packet which may be accomplished by synchronizing the content library in the multi-tenant database with the contents of the portable user system. In step 404 the portable user system receives customized sales information packet, customized for the a customer including customized sales material, daily schedule and customer information. In an embodiment the customized sales material may not be modified by the sales personnel. In step 406 the portable user system starts the sales session by checking-in. Check-in may be accomplished by sending geographical coordinates and start time of the sales session along with customer name to the server system and selecting the sales material. In step 408 the portable user system runs the sales material. During the session, input from the input device may be noted along with the name of the document, page number of the document, and the co-ordinates of the screen in case of a touch sensitive device or mouse. In step 410 the portable user system receives feedback from customer regarding the quality and effectiveness of the sales material and the interaction of the sales personnel. In an embodiment, the feedback may be rated in a 5-star system. In another embodiment, the feedback may be on a scale of 1-10. In step 412 the portable user system receives feedback from the sales personnel regarding effectiveness of the sales material and/or sales session. In step 414, the portable user system collects the customer interaction information. In step 416 the customer interaction information and feedback are sent to the server system.

In an embodiment, each of the steps of method 400 may be a distinct step. In other embodiments, method 400 may not have all of the above steps and/or may have other steps in addition to or instead of those listed above. The steps of method 400 may be performed in another order. Subsets of the steps listed above as part of method 400 may be used to form their own method. In an embodiment, there could be multiple instances of method 400.

### Screenshots

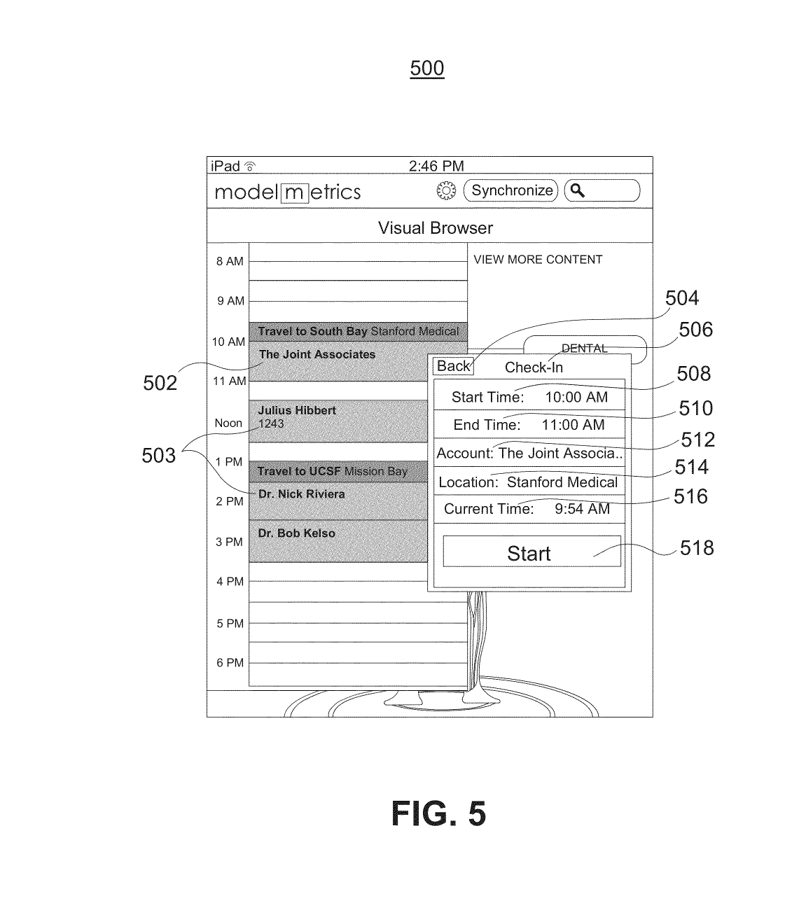

FIG. 5 shows screenshot 500 of an embodiment of a daily schedule with a check-in window on a portable user system. Screenshot 500 may include current appointment 502, other appointments 503, back button 504, window title 506, start time 508, end time 510, account 512, location 514, time 516, and start button 518. In other embodiments, screenshot 500 may not have all of the elements listed and/or may have other elements instead of or in addition to those listed.

Screenshot 500 shows a check-in window which may be the first step of a sales session. Screenshot 500 shows the daily schedule in the background. Current appointment 502 shows the current appointment. Selecting current appointments 502 may cause a check-in window to popup as shown in screenshot 500. Alternatively, a different process may cause the check-in window to pop-up, such as a process for checking the times of scheduled appointments and initiating a check-in prompt if the current time is close enough to the time of a scheduled appointment. Other appointments 503 are other appointments for the day along with the location of the appointment. Back button 504 is a button on the check-in window, when selected closes the check-in window. Title 506 is the check-in window title, which informs the user that the popup window displayed is for checking in. Start time 508 shows the start time of the appointment. End time 510 shows the end time of the scheduled appointment. Account 512 shows the name of the sales account or the customer. Location 514 shows the location of the appointment. Time 516 shows the current time. Start button 518 starts the sales presentation by displaying the sales material. The data displayed in the check-in window may be sent to the application server system.

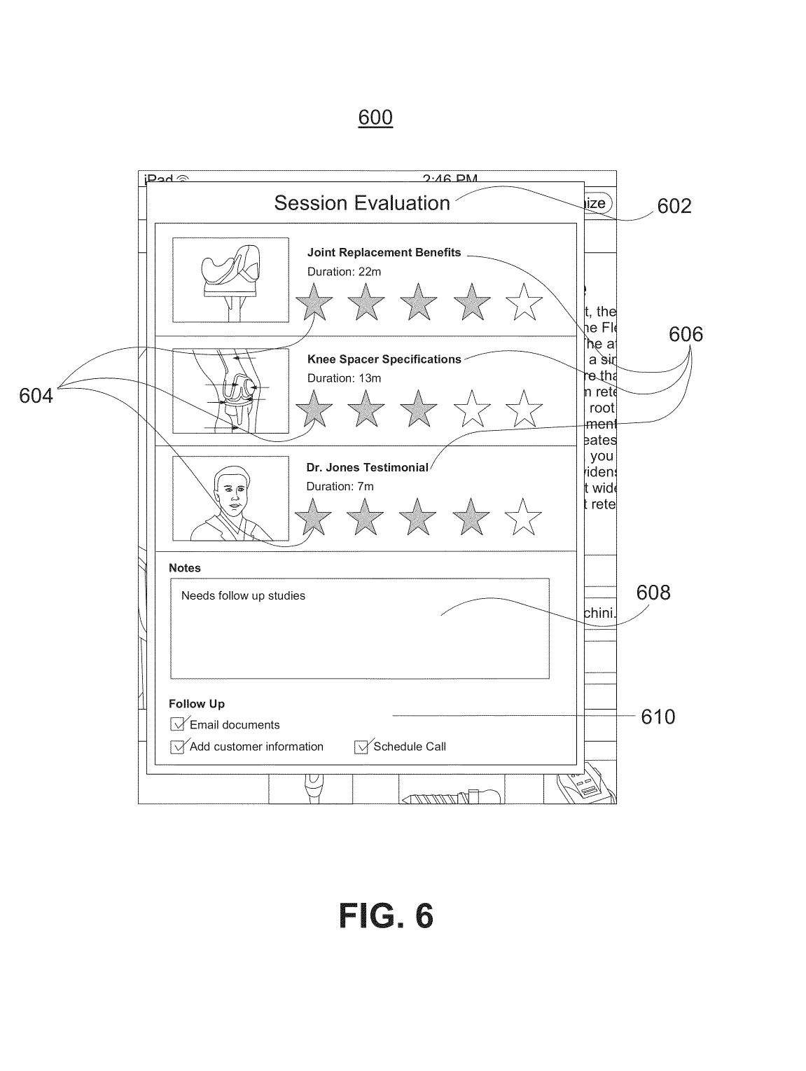

FIG. 6 shows screenshot 600 of an embodiment of a session evaluation by sales personnel on a portable user system. Screenshot 600 may include title 602, star rating 604, sales presentation title 606, notes 608, and follow-up 610. In other embodiments, screenshot 600 may not have all of the elements listed and/or may have other elements instead of or in addition to those listed.

Title 602 shows the title of the current window, session evaluation. Session evaluation may be a pop up screen with an interface to evaluate the sales session. Star rating 604 may be a star based rating element for rating the sales material. Sales presentation title 606 displays the titles of the presentations that were presented during the sales session along with the duration of the each presentation. Notes 608 may be notes from the sales personnel regarding the sales session, sales material or customer. Follow-up 610 may be a list of follow up tasks that may be performed by the sales personnel. In an embodiment, the follow up tasks are a series of suggested follow up items, and each follow up item has a check box next to the follow up item. In an embodiment, the suggested follow-up items include e-mail documents, schedule calls, and add customer information.

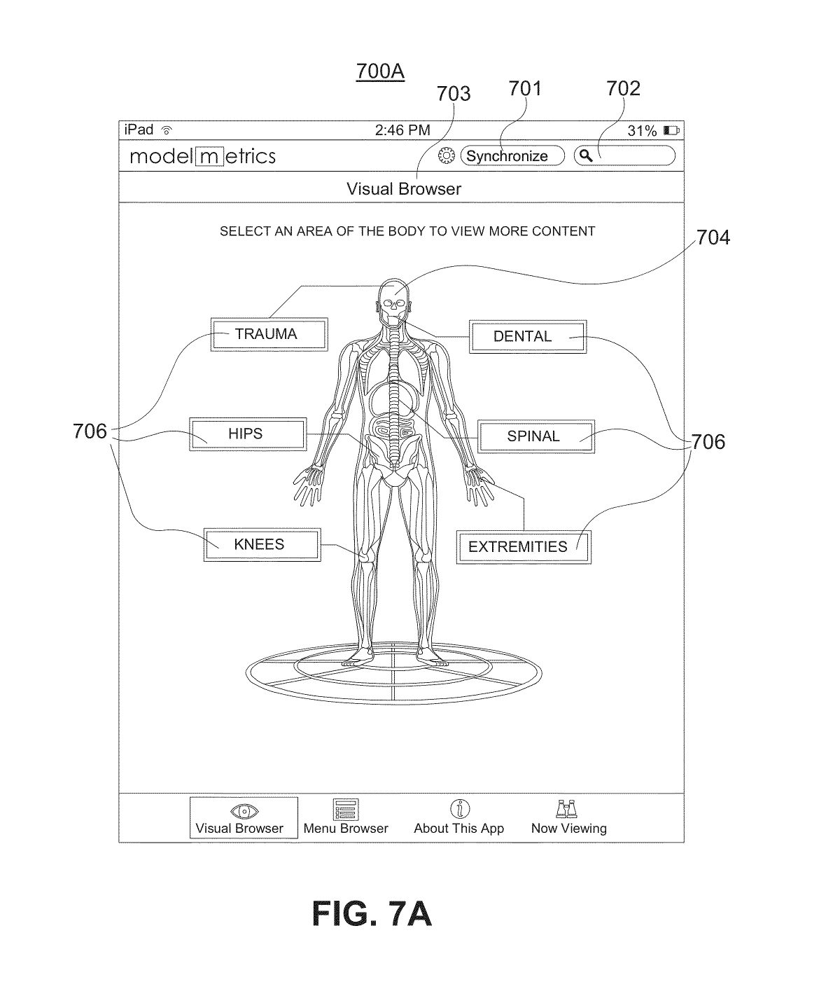

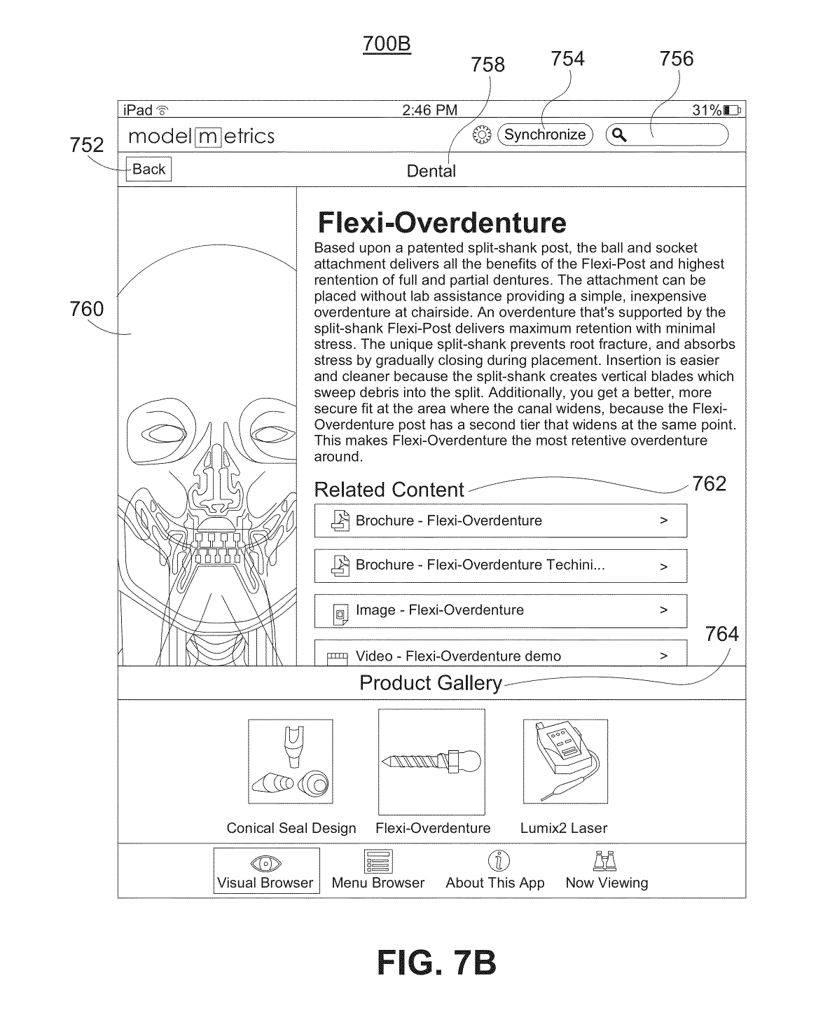

FIG. 7A shows screenshot 700A of an embodiment of a sales presentation on a portable user system. Screenshot 700A may include synchronize button 701, search 702, title 703, background image 704, and buttons 706. In other embodiments, screenshot 700A may not have all of the elements listed and/or may have other elements instead of or in addition to those listed.

Synchronize button 701, when selected, synchronizes the sales material on the portable user system with sales material on the server system. In an embodiment, the selection of synchronize button 701 forces an update on the sales material. However, document updates may also occur in the background, or directly pushed to the device. For example, a representative might use a document that contains outdated information. An admin can then force an update without the reps involvement. In another embodiment, the sales material may be updated from multi-tenant system 101.

Search 702 is the input box for searching terms/phrases in the sales material. Title 703 may be the title of the sales material. Background image 704 may be the background image of the first screen of the sales material. Buttons 706 may be buttons which, when selected, present more information about the topic displayed on the button. For example, selecting a dental button displays more information about matter related to dental content such as FIG. 7B.

FIG. 7B shows screenshot 700B of an embodiment of sales presentation with more information on a selected topic on a portable user system. Screenshot 700B may include back button 752, synchronize button 754, search 756, title 758, selected part 760, related content 762, and product gallery 764. In other embodiments, screenshot 700B may not have all of the elements listed and/or may have other elements instead of or in addition to those listed.

Back button 752, when selected, displays the previous screen which may be FIG. 7A. Synchronize button 754, when selected, synchronizes the sales material on the portable user system with the sales material on the server system. Search 756 is an input box for entering words and/or phrases for searching. Title 758 displays the title of display window. Selected part 760 displays the selected portion of the background image 704. Related content 762 lists other related documents available in the content library. The documents may be in any format such as text, image, and/or video. Product gallery 764 displays other products of the tenant.

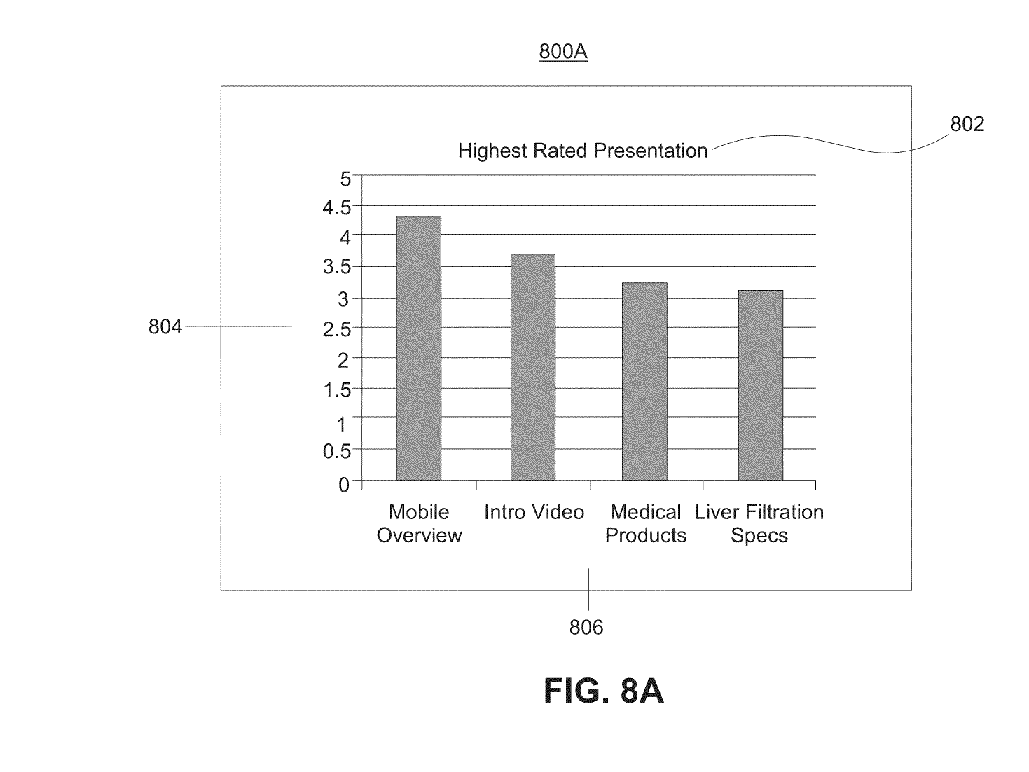

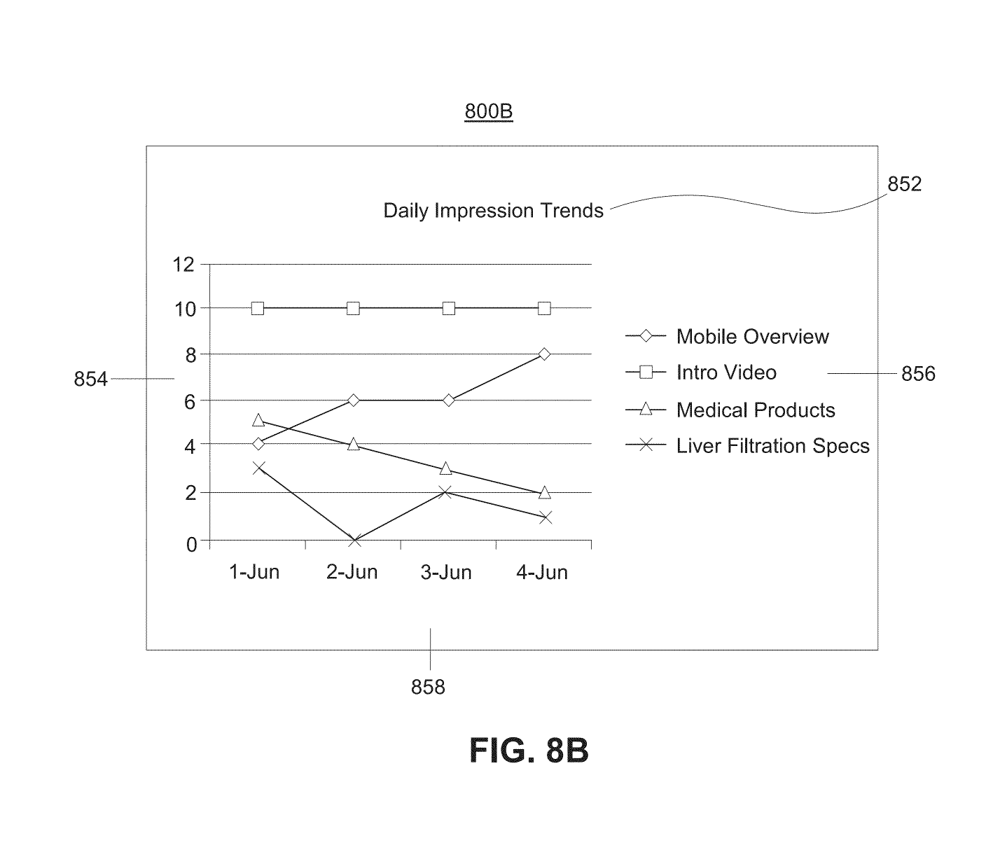

FIG. 8A shows a screenshot of an example of a sales analytics report on the rating of an average sales presentation. Screenshot 800A may include title 802, y-axis 804, and x-axis 806. In other embodiments, screenshot 800A may not have all of the elements listed and/or may have other elements instead of or in addition to those listed.

Screenshot 800A shows sales analytics report of sales presentation with highest rating using 5-stars presented in the form of a bar graph. Title 802 displays the title of the report. Y-axis 804 is the y-axis of the chart with average rating. The minimum rating is 0 and the maximum rating is 5 for sales presentation. X-axis 806 is the x-axis of the chart with titles of sales presentations with highest average-rating.

FIG. 8B shows a screenshot of an embodiment of a sales analytics report on number of views of presentations. Screenshot 800B may include title 852, y-axis 854, legend 856, and x-axis 858. In other embodiments, screenshot 800B may not have all of the elements listed and/or may have other elements instead of or in addition to those listed.

Screenshot 800B shows a sales analytics report of a number of views of sales presentations on certain days. The report is presented in the form of a line graph. Title 852 displays the title of the report. Y-axis 854 is the y-axis of the chart with the number of views. 856 legend shows the legend of the line graph correlating the line type with the names of sales presentation. X-axis 858 is the x-axis of the chart with dates on which the sales presentations were presented to customers.

### System Overview

FIG. 9 illustrates a block diagram of an environment 910 wherein an on-demand database service might be used. Environment 910 may include user systems 912, network 914, system 916, processor system 917, application platform 918, network interface 920, tenant data storage 922, system data storage 924, program code 926, and process space 928. In other embodiments, environment 910 may not have all of the components listed and/or may have other elements instead of, or in addition to, those listed above.

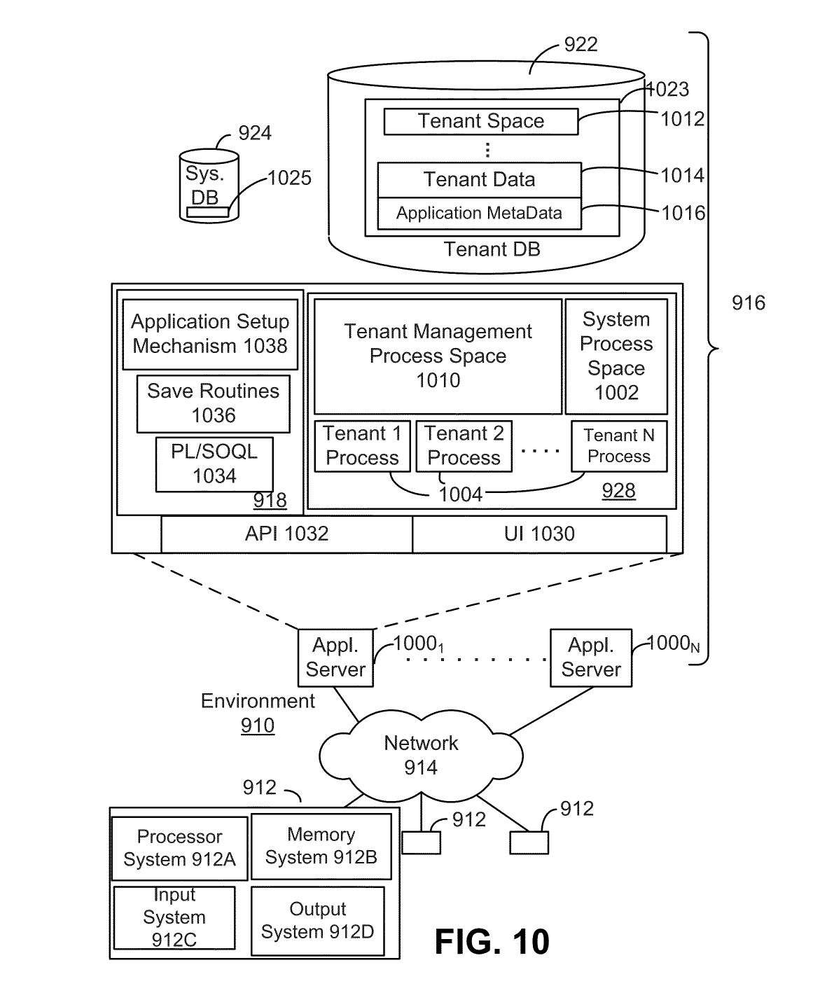

Environment 910 is an environment in which an on-demand database service exists. User system 912 may be any machine or system that is used by a user to access a database user system. For example, any of user systems 912 can be a handheld computing device, a mobile phone, a laptop computer, a work station, and/or a network of computing devices. As illustrated in FIG. 9 (and in more detail in FIG. 10) user systems 912 might interact via a network 914 with an on-demand database service, which is system 916.

An on-demand database service, such as system 916, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, “on-demand database service 916” and “system 916” will be used interchangeably herein. A database image may include one or more database objects. A relational database management system (RDMS) or the equivalent may execute storage and retrieval of information against the database object(s). Application platform 918 may be a framework that allows the applications of system 916 to run, such as the hardware and/or software, e.g., the operating system. In an embodiment, on-demand database service 916 may include an application platform 918 that enables creation, managing and executing one or more applications developed by the provider of the on-demand database service, users accessing the on-demand database service via user systems 912, or third party application developers accessing the on-demand database service via user systems 912.

The users of user systems 912 may differ in their respective capacities, and the capacity of a particular user system 912 might be entirely determined by permissions (permission levels) for the current user. For example, where a salesperson is using a particular user system 912 to interact with system 916, that user system has the capacities allotted to that salesperson. However, while an administrator is using that user system to interact with system 916, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 914 is any network or combination of networks of devices that communicate with one another. For example, network 914 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it should be understood that the networks that the one or more implementations might use are not so limited, although TCP/IP is a frequently implemented protocol.

User systems 912 might communicate with system 916 using TCP/IP and, at a higher network level, use other common Internet protocols to communicate, such as HTTP, FTP, AFS, WAP, etc. In an example where HTTP is used, user system 912 might include an HTTP client commonly referred to as a “browser” for sending and receiving HTTP messages to and from an HTTP server at system 916. Such an HTTP server might be implemented as the sole network interface between system 916 and network 914, but other techniques might be used as well or instead. In some implementations, the interface between system 916 and network 914 includes load sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In one embodiment, system 916, shown in FIG. 9, implements a web-based customer relationship management (CRM) system. For example, in one embodiment, system 916 includes application servers configured to implement and execute CRM software applications as well as provide related data, code, forms, webpages and other information to and from user systems 912 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, system 916 implements applications other than, or in addition to, a CRM application. For example, system 916 may provide tenant access to multiple hosted (standard and custom) applications, including a CRM application. User (or third party developer) applications, which may or may not include CRM, may be supported by the application platform 618, which manages creation, storage of the applications into one or more database objects and executing of the applications in a virtual machine in the process space of the system 916.

One arrangement for elements of system 916 is shown in FIG. 9, including a network interface 920, application platform 918, tenant data storage 922 for tenant data 1023, system data storage 924 for system data 1025 accessible to system 916 and possibly multiple tenants, program code 926 for implementing various functions of system 916, and a process space 928 for executing MTS system processes and tenant-specific processes, such as running applications as part of an application hosting service. Additional processes that may execute on system 916 include database indexing processes.

Several elements in the system shown in FIG. 9 include conventional, well-known elements that are explained only briefly here. For example, each user system 912 could include a desktop personal computer, workstation, laptop, PDA, cell phone, or any wireless access protocol (WAP) enabled device or any other computing device capable of interfacing directly or indirectly to the Internet or other network connection. User system 912 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 912 to access, process and view information, pages and applications available to it from system 916 over network 914. Each user system 912 also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) in conjunction with pages, forms, applications and other information provided by system 916 or other systems or servers. For example, the user interface device can be used to access data and applications hosted by system 916, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each user system 912 and all of its components are operator configurable using applications, such as a browser, including computer code run using a central processing unit such as an Intel Pentium® processor or the like. Similarly, system 916 (and additional instances of an MTS, where more than one is present) and all of their components might be operator configurable using application(s) including computer code to run using a central processing unit such as processor system 917, which may include an Intel Pentium® processor or the like, and/or multiple processor units. A computer program product embodiment includes a machine-readable storage medium (media) having instructions stored thereon/in which can be used to program a computer to perform any of the processes of the embodiments described herein. Computer code for operating and configuring system 916 to intercommunicate and to process webpages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to one embodiment, each system 916 is configured to provide webpages, forms, applications, data and media content to user (client) systems 912 to support the access by user systems 912 as tenants of system 916. As such, system 916 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 10 also illustrates environment 910. However, in FIG. 10 elements of system 916 and various interconnections in an embodiment are further illustrated. FIG. 10 shows that user system 912 may include processor system 912A, memory system 912B, input system 912C, and output system 912D. FIG. 9 shows network 914 and system 916. FIG. 10 also shows that system 916 may include tenant data storage 922, tenant data 1023, system data storage 924, system data 1025, User Interface (UI) 1030, Application Program Interface (API) 1032, PL/SOQL 1034, save routines 1036, application setup mechanism 1038, applications servers 1000₁-1000_{N}, system process space 902, tenant process spaces 904, tenant management process space 910, tenant storage area 912, user storage 914, and application metadata 916. In other embodiments, environment 910 may not have the same elements as those listed above and/or may have other elements instead of, or in addition to, those listed above.

User system 912, network 914, system 916, tenant data storage 922, and system data storage 924 were discussed above in FIG. 9. Regarding user system 912, processor system 912A may be any combination of one or more processors. Memory system 912B may be any combination of one or more memory devices, short term, and/or long term memory. Input system 912C may be any combination of input devices, such as one or more keyboards, mice, trackballs, scanners, cameras, and/or interfaces to networks. Output system 912D may be any combination of output devices, such as one or more monitors, printers, and/or interfaces to networks. As shown by FIG. 9, system 916 may include a network interface 920 (of FIG. 9) implemented as a set of HTTP application servers 1000, an application platform 918, tenant data storage 922, and system data storage 924. Also shown is system process space 902, including individual tenant process spaces 904 and a tenant management process space 910. Each application server 1000 may be configured to tenant data storage 922 and the tenant data 1023 therein, and system data storage 924 and the system data 1025 therein to serve requests of user systems 912. The tenant data 1023 might be divided into individual tenant storage areas 912, which can be either a physical arrangement and/or a logical arrangement of data. Within each tenant storage area 912, user storage 914 and application metadata 916 might be similarly allocated for each user. For example, a copy of a user's most recently used (MRU) items might be stored to user storage 914. Similarly, a copy of MRU items for an entire organization that is a tenant might be stored to tenant storage area 912. A UI 1030 provides a user interface and an API 1032 provides an application programmer interface to system 916 resident processes to users and/or developers at user systems 912. The tenant data and the system data may be stored in various databases, such as one or more Oracle™ databases.

Application platform 918 includes an application setup mechanism 1038 that supports application developers' creation and management of applications, which may be saved as metadata into tenant data storage 922 by save routines 1036 for execution by subscribers as one or more tenant process spaces 904 managed by tenant management process 910 for example. Invocations to such applications may be coded using PL/SOQL 1034 that provides a programming language style interface extension to API 1032. A detailed description of some PL/SOQL language embodiments is discussed in commonly owned co-pending U.S. Provisional Patent Application 60/828,192 entitled, PROGRAMMING LANGUAGE METHOD AND SYSTEM FOR EXTENDING APIS TO EXECUTE IN CONJUNCTION WITH DATABASE APIS, by Craig Weissman, filed Oct. 4, 2006, which is incorporated in its entirety herein for all purposes. Invocations to applications may be detected by one or more system processes, which manage retrieving application metadata 916 for the subscriber making the invocation and executing the metadata as an application in a virtual machine.

Each application server 1000 may be communicably coupled to database systems, e.g., having access to system data 1025 and tenant data 1023, via a different network connection. For example, one application server 1000₁ might be coupled via the network 914 (e.g., the Internet), another application server 1000_{N-1} might be coupled via a direct network link, and another application server 1000_{N} might be coupled by yet a different network connection. Transfer Control Protocol and Internet Protocol (TCP/IP) are typical protocols for communicating between application servers 1000 and the database system. However, it will be apparent to one skilled in the art that other transport protocols may be used to optimize the system depending on the network interconnect used.

In certain embodiments, each application server 1000 is configured to handle requests for any user associated with any organization that is a tenant. Because it is desirable to be able to add and remove application servers from the server pool at any time for any reason, there is preferably no server affinity for a user and/or organization to a specific application server 1000. In one embodiment, therefore, an interface system implementing a load balancing function (e.g., an F5 Big-IP load balancer) is communicably coupled between the application servers 1000 and the user systems 912 to distribute requests to the application servers 1000. In one embodiment, the load balancer uses a least connections algorithm to route user requests to the application servers 1000. Other examples of load balancing algorithms, such as round robin and observed response time, also can be used. For example, in certain embodiments, three consecutive requests from the same user could hit three different application servers 1000, and three requests from different users could hit the same application server 1000. In this manner, system 916 is multi-tenant, wherein system 916 handles storage of, and access to, different objects, data and applications across disparate users and organizations.

As an example of storage, one tenant might be a company that employs a sales force where each salesperson uses system 916 to manage their sales process. Thus, a user might maintain contact data, leads data, customer follow-up data, performance data, goals and progress data, etc., all applicable to that user's personal sales process (e.g., in tenant data storage 922). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 916 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, system 916 might also maintain system level data usable by multiple tenants or other data. Such system level data might include industry reports, news, postings, and the like that are sharable among tenants.

In certain embodiments, user systems 912 (which may be client systems) communicate with application servers 1000 to request and update system-level and tenant-level data from system 916 that may require sending one or more queries to tenant data storage 922 and/or system data storage 924. System 916 (e.g., an application server 1000 in system 916) automatically generates one or more SQL statements (e.g., one or more SQL queries) that are designed to access the desired information. System data storage 924 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. U.S. patent application Ser. No. 10/8128,161, filed Apr. 2, 2004, entitled “Custom Entities and Fields in a Multi-Tenant Database System”, and which is hereby incorporated herein by reference, teaches systems and methods for creating custom objects as well as customizing standard objects in a multi-tenant database system. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

### Method for Using the Environment (FIGS. 9 and 10)

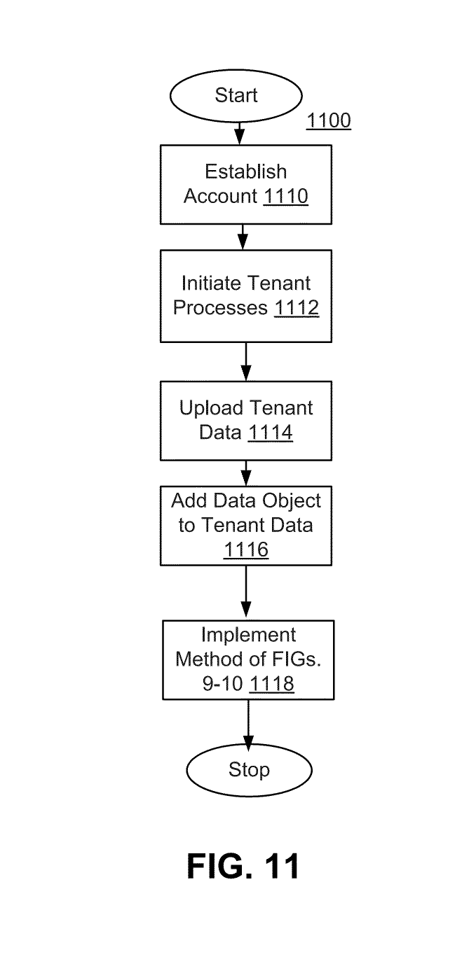

FIG. 11 shows a flowchart of an example of a method 1100 of using environment 910. In step 1110, user system 912 (FIGS. 9 and 10) establishes an account. In step 1112, one or more tenant process space 1004 (FIG. 10) is initiated on behalf of user system 912, which may also involve setting aside space in tenant space 1012 (FIG. 10) and tenant data 1014 (FIG. 10) for user system 912. Step 1112 may also involve modifying application metadata to accommodate user system 912. In step 1114, user system 912 uploads data. In step 1116, one or more data objects are added to tenant data 1014 where the uploaded data is stored. In step 1118, the methods associated with FIGS. 9-10 may be implemented. In another embodiment, although depicted as distinct steps in FIG. 11, steps 1102-1118 may not be distinct steps. In other embodiments, method 1100 may not have all of the above steps and/or may have other steps in addition to, or instead of, those listed above. The steps of method 1100 may be performed in another order. Subsets of the steps listed above as part of method 1100 may be used to form their own method.

### Method for Creating the Environment (FIGS. 9 and 10)

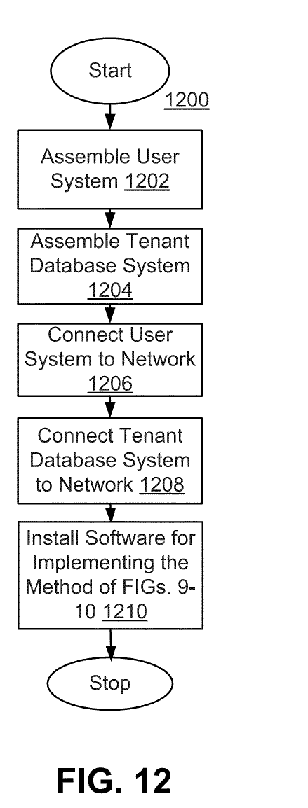

FIG. 12 is a method of making environment 910, in step 1202, user system 912 (FIGS. 9 and 10) is assembled, which may include communicatively coupling one or more processors, one or more memory devices, one or more input devices (e.g., one or more mice, keyboards, and/or scanners), one or more output devices (e.g., one more printers, one or more interfaces to networks, and/or one or more monitors) to one another.

In step 1204, system 916 (FIGS. 9 and 10) is assembled, which may include communicatively coupling one or more processors, one or more memory devices, one or more input devices (e.g., one or more mice, keyboards, and/or scanners), one or more output devices (e.g., one more printers, one or more interfaces to networks, and/or one or more monitors) to one another. Additionally assembling system 916 may include installing application platform 918, network interface 920, tenant data storage 922, system data storage 924, system data 1025, program code 926, process space 928, UI 1030, API 1032, PL/SOQL 1034, save routine 1036, application setup mechanism 1038, applications servers 100₁-100_{N}, system process space 102, tenant process spaces 1004, tenant management process space 110, tenant space 1012, tenant data 1014, and application metadata 1016 (FIG. 10).

In step 1206, user system 912 is communicatively coupled to network 1004. In step 1208, system 916 is communicatively coupled to network 1004 allowing user system 912 and system 916 to communicate with one another (FIG. 10). In step 1210, one or more instructions may be installed in system 916 (e.g., the instructions may be installed on one or more machine readable media, such as computer readable media, therein) and/or system 916 is otherwise configured for performing the steps of methods associated with FIGS. 9-10. In an embodiment, each of the steps of method 1200 is a distinct step. In another embodiment, although depicted as distinct steps in FIG. 12, steps 1202-1210 may not be distinct steps. In other embodiments, method 1200 may not have all of the above steps and/or may have other steps in addition to, or instead of, those listed above. The steps of method 1200 may be performed in another order. Subsets of the steps listed above as part of method 1200 may be used to form their own method.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

### EXTENSIONS AND ALTERNATIVES

In alternate embodiment, the customization of sales material may include native code. In another alternate embodiment, the customization of sales material may be done by sales personnel. In another alternate embodiment, a sales session may include a video-conference. Each embodiment disclosed herein may be used or otherwise combined with any of the other embodiments disclosed. Any element of any embodiment may be used in any embodiment.

Although the invention has been described with reference to specific embodiments, it will be understood by those skilled in the art that various changes may be made and equivalents may be substituted for elements thereof without departing from the true spirit and scope of the invention. In addition, modifications may be made without departing from the essential teachings of the invention.

1. A method of sales comprising:
sending a sales information packet to a user system from a host system, the host system including one or more machines having a processor system with one or more processors and a memory system that stores the sales information packet;
receiving, at the host system, feedback related at least to a client interaction that is part of a sales process, via the user system;
automatically determining, by the processor system, a measure of effectiveness of one or more aspects of the sales process based on the feedback.

2. The method of claim 1, the host system further including at least an on demand multi-tenant database system.

3. The method of claim 1, the user system being a first user system, the method further comprises:
receiving at the host system, the sales information packet from a second user system.

4. The method of claim 1, the information packet includes at least a presentation document.

5. The method of claim 4, the presentation document being in a multi-media format.

6. The method of claim 1, the information packet includes at least sales opportunities, daily schedule, sales account information, and contact details.

7. The method of claim 1, the feedback further includes at least effectiveness of a presentation document, effectiveness of a sales personnel, and effectiveness of a sales session received from a customer.

8. The method of claim 1, the feedback further includes at least feedback from a sales personnel, effectiveness of a presentation document, effectiveness of a sales session, follow up tasks and updated customer information.

9. The method of claim 1, the feedback includes a geographical coordinates of the machine of the user system.

10. The method of claim 1, the feedback includes duration of the client interaction.

11. The method of claim 1, the feedback includes at least an indication of start of a meeting.

12. The method of claim 1, the user system being a standalone system.

13. The method of claim 1, the measure of effectiveness includes at least a document effectiveness, a duration of document presentation and a customer impression from a plurality of client interactions.

14. The method of claim 1, the measure of effectiveness includes at least a duration of client interaction.

15. The method of claim 1, the measure of effectiveness includes at least a most effective document and a busiest sales representative.

16. The method of claim 1, the measure of effectiveness includes at least a geographical map overlaying a map of one or more activities of one or more sales personnel.

17. The method of claim 1, the client interaction includes the information derived from taps on a touch sensitive input device.

18. A device of sales comprising:
a processor system with one or more processors;
a memory system that stores a sales information packet including at least a presentation document;
a location determination system;
software code to collect information from taps on a touch sensitive input device;
software code to collect feedback from at least a customer and at least a personnel; and
software code to generate a daily schedule of the sales personnel.

19. A machine-readable medium carrying one or more sequences of instructions for implementing a method for providing an interface for object relationships, the method comprising:
sending a sales information packet to a user system from a host system, the host system including one or more machines having a processor system with one or more processors and a memory system that stores the sales information packet;
receiving, at the host system, feedback related at least to a client interaction that is part of a sales process, via the user system;
automatically determining, by the processor system, a measure of effectiveness of one or more aspects of the sales process based on the feedback.
